(19) United States
(12) Patent Application Publication
(10) Pub. No.: US 2010/0114654 A1
(43) Pub. Date: May 6, 2010

(54) LEARNING USER PURCHASE INTENT FROM USER-CENTRIC DATA

(75) Inventors: Rajan Lukose, Oakland, CA (US); Jiye Li, Waterloo (CA); Jing Zhou, Concord, NC (US); Satyanarayana Raju P. Venkata, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/263,176

(22) Filed: Oct. 31, 2008

(51) Int. Cl. G06Q 30/00

(52) U.S. Cl. 705/10

(57) ABSTRACT

A method of predicting user purchase intent from user-centric data includes applying a classification model to a user-centric clickstream, where the classification model predicting a likelihood of a future user purchase by a user within one or more product categories, and customizing content displayed to the user based on the likelihood of future user purchase. A system of predicting user purchase intent from user-centric data includes a computer programmed to record a user's clickstream data as a user accesses a plurality of different websites. The computer is also loaded with a classification model configured to predict a likelihood of a future user purchase by the user within one or more product categories based on the clickstream data. A method of predicting user purchase intent from user-centric data includes, with a user's own computer, recording user-centric clickstream data based on visits to a plurality of different websites; and storing a smart cooked based on the clickstream data on the user's own computer.

### BACKGROUND

Many Internet sites seek to personalize the data served to a particular user based on that user's previous activity. The previous activity is taken as an indicator of what information the user will be most interested in seeing from the site in the future.

Most existing personalization systems rely on site-centric user data, in which the inputs available to the system are the user's behavior on a specific site. One example of an existing personalization system using site-centric user data is a news site which personalizes the presented content based on the user's retrieval of other articles on the site. Another example is a search engine which serves advertisements based on the user's search query. While these simple personalization schemes can be effective, online personalization can be a more powerful tool for improving the user's online experience if a more comprehensive understanding of the user's intention can be derived from the user's online behavior.

Online advertisers are particularly interested in the ability to identify, in advance, users who intend to purchase a product within a particular product category. By identifying users who intend to purchase a product, the advertisers can present relevant options and information which will allow the user to make a more informed choice in their purchase. However, because a user's online purchasing behavior is rarely limited to a single site, existing site-centric personalization systems are inadequate.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of an illustrative system for learning user purchase intent from user-centric data, according to one embodiment of principles described herein.

FIG. 2 is an illustrative chart showing search terms derived from a training set that indicate a probability of user purchase, according to one embodiment of principles described herein.

FIG. 3 is a flowchart showing an illustrative method for performing a behavioral analysis of search terms to select the most significant terms for predicting future purchasing behavior, according to one embodiment of principles described herein.

FIG. 4 is a chart showing illustrative features for learning user purchase intent, according to one embodiment of principles described herein.

FIG. 5 is an illustrative chart showing the application of various features to user clickstreams, according to one embodiment of principles described herein.

FIG. 6 is an illustrative confusion matrix, according to one embodiment of principles described herein.

FIG. 7 is an illustrative graph of a precision/recall curve generated by a logical regression classification over varying threshold values, according to one embodiment of principles described herein.

FIG. 8 is an illustrative Relative Operating Characteristic (ROC) curve for varying threshold values within a logical regression model, according to one embodiment of principles described herein.

FIG. 9 shows illustrative relationships between cutoff threshold and precision/recall measures, according one embodiment of principles described herein.

FIG. 10 is an illustrative chart which compares the performance of site-centric and user-centric approaches in predicting purchase behavior, according to one embodiment of principles described herein.

FIG. 11 is a flowchart showing an illustrative method for learning user purchase intent from user-centric data, according to one embodiment of principles described herein.

Throughout the drawings, identical reference numbers designate similar, but not necessarily identical, elements.

### DETAILED DESCRIPTION

People increasingly use their computers and the Internet to research and purchase products. For example, users may go online to determine which products are available to fulfill a particular need. In conducting such research, a user may enter search terms related to the need or product category into a search engine. They may explore various websites that are returned by the search engine to determine which products are available. After identifying a product that they believe is suitable, they may do more in depth research about the product, identify which retailers sell the product, compare prices between various sources, look for coupons or sales, etc. A portion of the users will eventually purchase the product online. Another segment of users will use the information gained through their online research in making an in-person purchase at a bricks-and-mortar store.

Determining in advance which users have an intent to purchase an item within a specific product category allows for more efficient advertising and can lead to a more productive user experience. If user purchase intent is correctly identified, search results could be better selected to present information of interest to the users. Additionally, targeted advertising could be presented to the users to inform them of additional options for obtaining the product or service they are interested in.

To identify the probability that a user will make a purchase within a specific product category, the user's clickstream can be analyzed. A clickstream is the record of computer user actions while web browsing or using another software application. As the user clicks anywhere in the webpage or application, the action is logged on a client or inside the Web server, as well as possibly the Web browser, routers, proxy servers, and ad servers.

Clickstream analysis can be divided into two general areas: site-centric clickstreams and user-centric clickstreams. A site-centric clickstream focuses on the activity of a user or users within a specific website. The site-centric clickstream is typically captured at the server that supports the website. User-centric data focuses on the entire online experience of a specific user and contains site-centric data as a subset. Because the user-centric clickstream must capture the user's actions over multiple sites and servers, the user-centric clickstream is typically recorded at the user's computer or service provider.

The majority of computer science literature in this area is focused on site-centric clickstreams. The two main motivations that have driven research on site-clickstream analysis are (1) improving web server management and (2) personalization. Web server management can be improved by predicting content the user is likely to request based on the site-centric clickstream and pre-fetching and/or caching the content. The content can then be served to the user more quickly when they later make the predicted request. This type of site-centric clickstream analysis has emphasized the use of Markov models to predict page accesses.

Another motivation for site-centric analysis of clickstreams is to present personalized content to a user based on the user's actions within the site. Typically, personalization efforts have used site-centric clickstream analysis to cluster users which enables further site-specific content recommendations within user clusters. For example, Amazon.com keeps a browsing history that records the actions of each user within the Amazon site. Amazon analyzes this history to make product recommendations to individual users for items that are associated based on the activity of a user cluster with products they have previously viewed or purchased. Amazon makes these associations by analyzing the activities of groups of users who viewed or purchased similar products.

Additionally, site-centric work has been done to predict when a purchase will happen during the user's browsing. For example, a consumer's accumulative browsing history on a site can be indicative of a future or current purchase through that particular site. However, site-centric clickstreams are not capable of capturing the typical online purchasing behavior of the user as demonstrated across a variety of different websites.

As described above, a typical online purchasing behavior for a particular user is best assessed by observing the behavior of that user occur across a number of websites and servers. For example, online purchasing behavior may include: entering search terms related to the desired product category into various online search engines; browsing various websites that sell items within the product category; comparing features of a selected item to other similar items through a comparison shopping site; searching multiple sites for the best price on a desired item; using a price comparison site to compare prices from various online vendors; looking for coupons or sales within a specific site; and making the purchase of the desired item.

Consequently, user-centric clickstreams contain a more complete description of a specific user's actions and can be more effectively leveraged to understand the user's purchase intentions. In contrast to site-centric efforts which have attempted to predict purchasing behavior on a specific site, the task of analyzing user-centric clickstreams to predict specific product category purchases at any website is more difficult, but more widely applicable and thus potentially more valuable.

Clickstream data collected across all the different websites a user visits reflect the user's behavior, interests, and preferences more completely than data collected from the perspective of one site. For example, it is possible to better model and predict the intentions of users using clickstream data which shows that the user not only searched for a product using Google but also visited website X and website Y, than if only one of those pieces of information were known.

According to one illustrative embodiment, a number of user clickstreams are conglomerated into a training data set. The purchasing behavior of the users is extracted from the training data set and the users are divided into two categories: purchasers and non-purchasers. The data set is then analyzed to discover behavior patterns (“features”) which can be used to discriminate between purchasers and non-purchasers. These features may include a number of distinctive behaviors exhibited by purchasers or non-purchasers, such as a history of searching for specific keywords, visiting a retailer website, or the total number of pages viewed on a site. A variety of models can be used to generate and apply the features identified so as to predict purchasing behavior. These models include, but are not limited to, decision trees, logistic regression, Naive Bayes, association rules algorithms, and other data mining or machine learning algorithms.

The features extracted from the training data set are then applied to real time clickstreams to indicate the likelihood of a future purchase by a current online user. The model produces a likelihood of future purchase by the online user based on a comparison between the user's online behavior and the features. According to one embodiment, this likelihood of future purchase by a user can be encoded within a smart cookie which could be communicated to search engines or to content websites upon visitation or request. The smart cookie is unique in that it is generated by the user's own computer and not a web-server that the user is accessing.

The search engines or websites accessed by the user can then use the predicted likelihood that the use is a purchaser or non-purchaser to dynamically determine which ads or content to show the user. The end result would be more relevant content to users and greater revenue to content owners. Because the models would be computed from the clickstream rather than the user's behavior at only a single site, the user's eventual purchasing behavior can be more accurately predicted. Additionally, because of clickstream data is collected on the client-side, privacy issues are mitigated. The actual purchase behavior of the user could be observed and analyzed to iteratively update the model.

This method can be used to make predictions of purchases within a number of product categories. This allows content providers and advertisers to more tightly target potential purchasers, making the prediction of future purchase more valuable. Additionally, a user-centric approach which accounts for the behavior of the users over their entire online experience is significantly more accurate than site centric analysis.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

A data set supplied by Nielson Media Research represents a complete user-centric view of clickstream behavior and forms the basis for an experimental training data set. Nielson Media Research is a well known organization that collects and delivers information relating to viewing and online audiences. To collect user-centric clickstream data, Nielson Media Research contacts a representative sample of the online population and, with the user's permission, installs metering software on the user's home and work computers. The metering software captures and reports the user's complete clickstream data. Personal information is removed from this data and the data is conglomerated with data from other users to create a representative user-centric data set. This data set was used to implement and validate methods for learning user purchase intent from user-centric data described below. Specifically, the Nielson Media Research product MEGAPANEL was used. MEGAPANEL data is raw user-centric clickstream data. The data implicitly includes, for example, online search behavior on both leading search engines (such as Google and Yahoo) and shopping websites (such as Amazon and BestBuy). The data collection processes are designed in such a way that the average customers' online behaviors and their retention rate are consistent with the goal of representative sampling of Internet users. All personally identifying data is removed from the MEGAPANEL data set by Nielsen.

The MEGAPANEL data set included clickstream data collected over 8 months (from November 2005 to June 2006). This data amounted to approximately 1 terabyte from more than 100,000 households. For each Universal Resource Locator (URL), there are time stamps for each Internet user's visit. Retailer transaction data (i.e. purchase metadata) contains more than 100 online leading shopping destinations and retailer sites. These data records show for a given user who makes a purchase online the product name, the store name, the timestamp, the price, the tax, the shipping cost where possible, etc. The data also contains travel transaction data, such as air plane, car and hotel reservation histories. There are also users' search terms collected in the URL data. The search terms are collected from top search engines and comparison shopping sites. Additional search terms are extracted and customized from raw URL data by use (e.g., from Craigslist.org, which is a website for online classifieds and forums).

The purchase metadata was extracted from the data set and used to set up a prediction problem. Models were used to predict a user's probability of purchase within a time window for multiple product categories by using features that represent the user's browsing and search behavior on all websites. These models included decision trees, logistic regression, and Naive Bayes analysis. These models incorporated a number of features which describe determinative online behavior that relates to the probability of a user purchase.

One such feature is a novel behaviorally (as opposed to syntactically) based search term suggestion algorithm. This search term suggestion algorithm can more accurately predict the probability of future purchase based on user input to search engines.

As a baseline, the results of these models were compared to site-centric models that use data from a major search engine site. The user-centric models discussed below demonstrate substantial improvements in accuracy, with comparable and often better recall. The predictions generated by the model can be captured in a dynamic “smart cookie” that is expressive of a user's individual intentions and probability of taking a given action. This “smart cookie” can then be retrieved from the user's computer to communicate the user's intention to purchase a product.

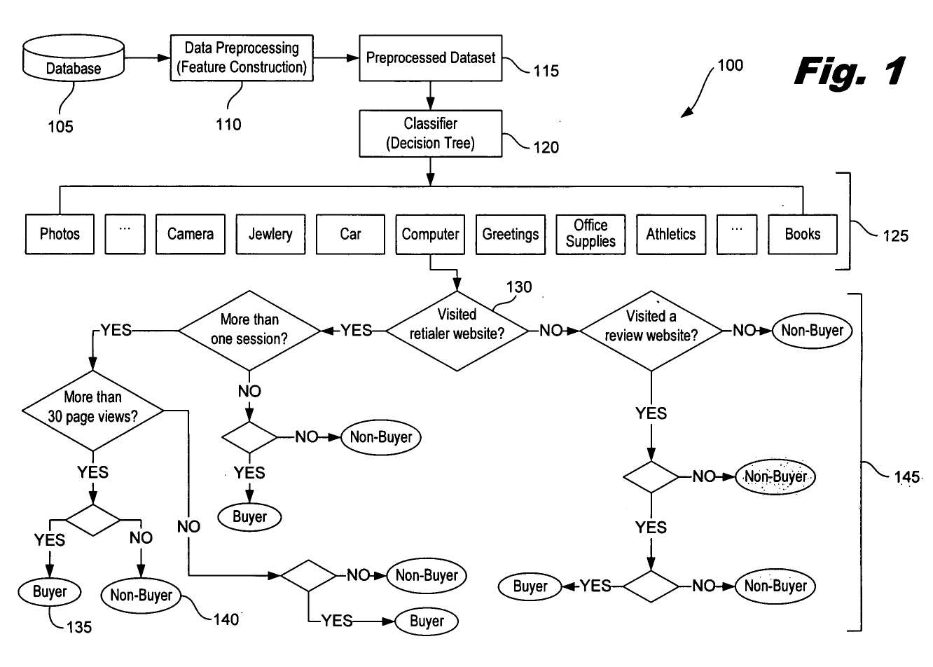

FIG. 1 is a diagram of an illustrative purchase intent prediction model (100). User-centric data is collected and stored in the database (105). A data preprocessing module (110) then removes missing attributes and incomplete data records. According to one embodiment, the data preprocessing module (110) also generates features reflecting user online behavior. For example, these features may include search terms that were entered, number of sites visited, types of sites visited, number of pages viewed within a specific site, etc. A number of techniques can be used to derive appropriate features, including but not limited to data mining and machine learning algorithms. Various illustrative methods for feature selection are discussed below.

This preprocessed data set (115) is then output and stored. The data is then categorized by a classifier module (120) into predicted buyer and non-buyer groups for various product categories. According, to one illustrative embodiment, consumer purchases are divided into a number of product categories (125). A decision tree (145) is then used to show the various features (130), predicted buyers (135) and predicted non-buyers (140). Features (130) are shown as diamond decision boxes. Each feature (130) represents a criterion which is applied to a user clickstream. In this embodiment, the user behavior represented by the clickstream either meets the criteria (YES) or does not meet the criteria (NO). The various decision tree branches end when the relevant users are finally categorized into either a predicted buyer group (135) or non-buyer group (140). Some branches are short, indicating that relatively few features are needed to categorize users displaying a given set of behaviors. In the illustrative decision tree for computer purchases, which is shown in FIG. 1, users who didn't visit a retailer website or a review website were predicted to be non-buyers. Other branches of the decision tree are longer, indicating that more features are needed to categorize users.

FIG. 1 is only one illustrative system and method for predicting user purchase intent. A variety of feature extraction and construction methods could be used. By way of example and not limitation, data mining and machine learning algorithms, decision trees, logistic regression, Naive Bayes, association rules algorithms, and other prediction algorithms can be used to generate and apply features.

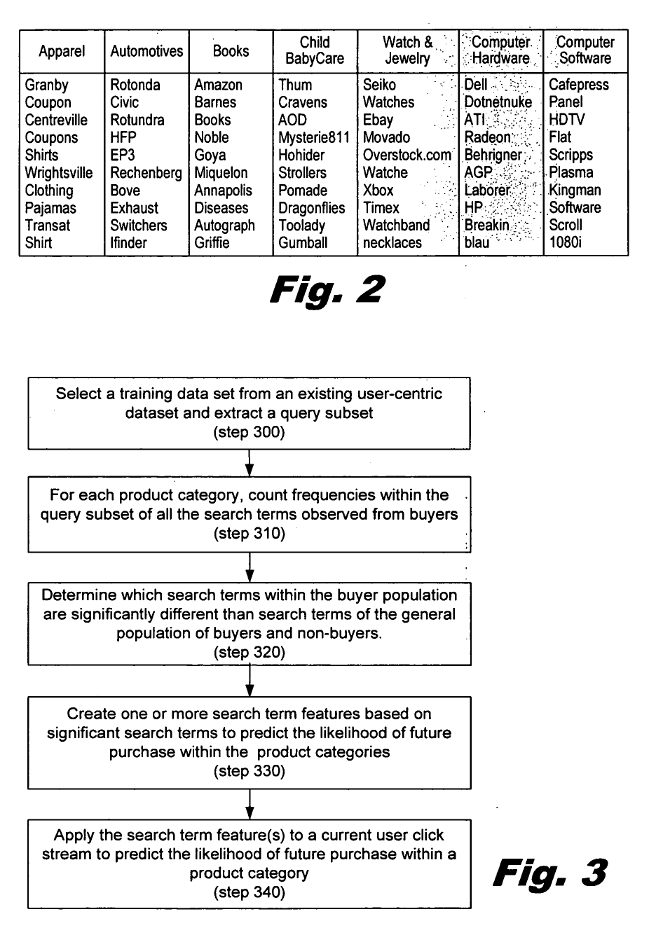

FIG. 2 is an illustrative chart showing search terms derived from a training data set that indicate a probability of user purchase. The search terms a user inputs into search engines are considered strong indicators of the user's purchasing intent. In the past, search term analysis was directed toward making syntactically based suggestions of alternative advertising keywords and amounted to little more than a lookup of similar words from a thesaurus-like table. For example, for the search term “laptop”, suggested keywords may include “computer”, “computers”, “laptop”, “laptops”.

However, rather than use search term syntax as a basis of making associations between a search term and a product category or purchase intent, a behavioral based approach can be used. First, the search term queries made by all users over a one month period of time were collected. Next, search terms entered by actual buyers of within a product category were identified. The frequency that each search term was used was determined. Then, search terms were identified which were significantly different within the buyer population from the search terms which appear in the general population of buyers (buyers in other product categories) and non-buyers. A Z-value test was used to examine the significance of search terms in each of the 26 product categories.

According to one illustrative embodiment, the Z-value test was implemented as described below. Let T be the set of all the search terms customers used in various kinds of search engines in a December 2005 search table. Some terms may exist multiple times in T. Tᵢ is the set of all search terms used by people who bought within product category cᵢ where

cᵢ ε(1≦i≦26) Eq. 1

The variable t is a search term that appears in T. Denote by A the total number of distinct search terms in T; let A′ be the number of times t occurs in T; let B be the total number of distinct search terms in Ti; let B′ be the number of times t occurs in Tᵢ. Let the term frequency for t in T be A′/A and the term frequency for t in Tᵢ be B′/B. The value t_{z} is the z-value for the term t determined according to the following equation:

$${t}_{z} = \frac{\frac{{A}^{′}}{A} - \frac{{B}^{′}}{B}}{\sqrt[2]{( \frac{{A}^{′} + {B}^{′}}{A + B} ) \times ( 1 - \frac{{A}^{′} + {B}^{′}}{A + B} ) \times ( \frac{1}{B} + \frac{1}{A} )}} \qquad Eq . 2$$

The value t_{z} was calculated for all terms in T and then the terms were listed in descending order of significance. This procedure was applied to Nielson data from the month of December 2005. FIG. 2 is a chart showing illustrative top 10 significant terms for five sample product categories. The assumption of the experiments is that people who bought a certain product (such as a laptop) are more likely to search for an associated term (such as “Dell,” “HP,” “Radeon,” or “ATI”) than the random user in the Internet population. This approach measures how significant the frequency of a certain term is versus all the customers (both buyer and non-buyers). The search terms extracted from this proposed behavior based search term algorithm are useful to capture users' online purchasing intentions, although it is not perfect due to statistical noise.

FIG. 3 is a summary of the method described above for performing a behavioral analysis of search terms to select the most significant terms for predicting future purchasing behavior. First, a training data set is selected from an existing user-centric data set (step 300). From the query terms within the training subset, all search terms observed from actual buyers are identified and the number of times (count frequency) that the term was used by all the actual buyers is determined (step 310). Next, search terms within the buyer population which are significantly different than search terms of the population of general buyers and non-buyers are determined (step 320). These distinguishing search terms are used to create one or more search term features to predict the likelihood that a search term captured from a real time clickstream represents an intention to purchase a product within a certain product category (step 330). Next, the search term features are applied to a current user clickstream and a prediction is made of the probability that the user will be a purchaser within a product category (step 340). This illustrative algorithm is one method for automatically constructing useful features for predicting online product purchases using search terms.

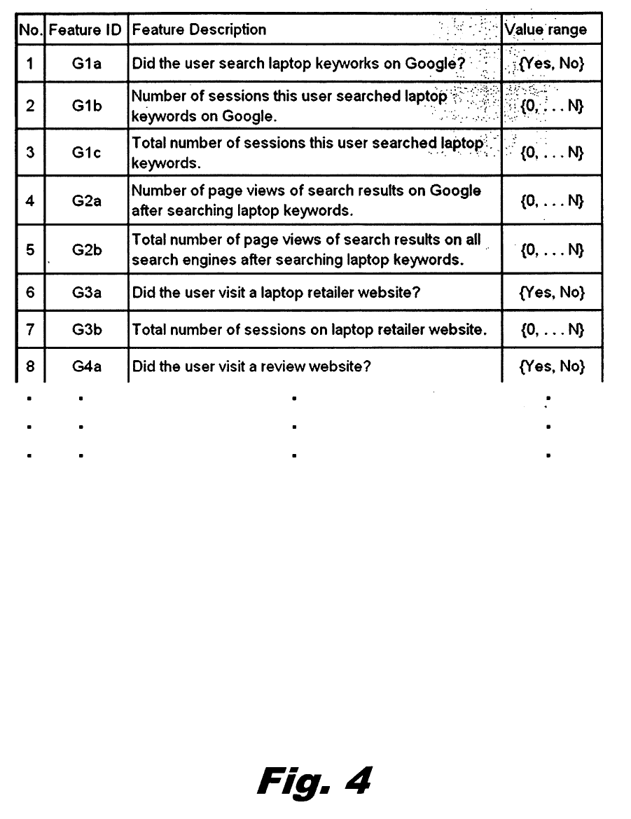

In addition, a number of other features can be used to predict the purchasing behavior of users. FIG. 4 is a chart which illustrates a variety of other features which can be constructed to learn purchase intent from user-centric clickstream data. In the example illustrated in FIG. 4, the features are related to the purchase of a laptop within a computer product category. The first column of the chart lists a feature reference number and the second column lists a feature identifier. The third column gives a description of the feature and the final column lists the value ranges for each feature.

For example, a feature number 1 has a feature identifier of “G1a” and a description: “Did the user search laptop keywords on Google?” The value range for this feature indicates that the expected answer is “Yes” or “No”. By way of example and not limitation, these laptop keywords could be determined using the method illustrated in FIG. 3.

Feature number 2 has a feature identifier of “G1b” and a description: “Number of sessions this user search laptop keywords on Google.” The value range for this feature indicates that the expected answer is a number between 0 and N. For example, if a user searches for a laptop keyword such as “dell latitude” using Google, feature number 1 would have a value of “YES” and feature number 2 would have a value of “1.” If the user searched for laptop keywords in four additional sessions using Google, the value of feature number 2 would be “5”.

As can be seen from the feature descriptions listed in FIG. 4, many of the user-centric features capture user behavior across multiple websites. For example, feature “G3b” captures the total number of sessions the user spent browsing laptop retailer websites. There may be any number of features created to predict the probability of user purchases. According to one embodiment, each product category has its own set of features that can be used to predict user purchases within that product category.

FIG. 5 is a decision table which illustrates the application of 28 features within a particular product category to user-centric clickstreams. A first column shows a numerical user identifier from 1 to 83,635. The 28 features, G1a through G16 are listed across the decision table. Each of the 28 features is applied to each of the 83,635 user clickstreams, resulting in a 28×83,635 matrix. Additionally, in the last column, the actual purchase behavior of each user is extracted from the user clickstream. By way of example and not limitation, the actual purchase behavior could discovered by examining information contained with the clickstream such as the product name, the store name, the timestamp, the price, the tax, the shipping cost, etc.

This decision table represents the preprocessed data set 115 illustrated in FIG. 1. Various models can then be applied to the information contained within the 28×83,635 matrix to predict whether an actual purchase will be made. The effectiveness of the model can then be determined by comparing the predicted outcome with actual purchase behavior contained in the last column. After a particular model is validated on this training data, it can be applied to real-time clickstreams to predict, in advance, the probability of user making a purchase within a particular product category. The online experience of that user can then be customized for more efficient advertising and a more productive user experience.

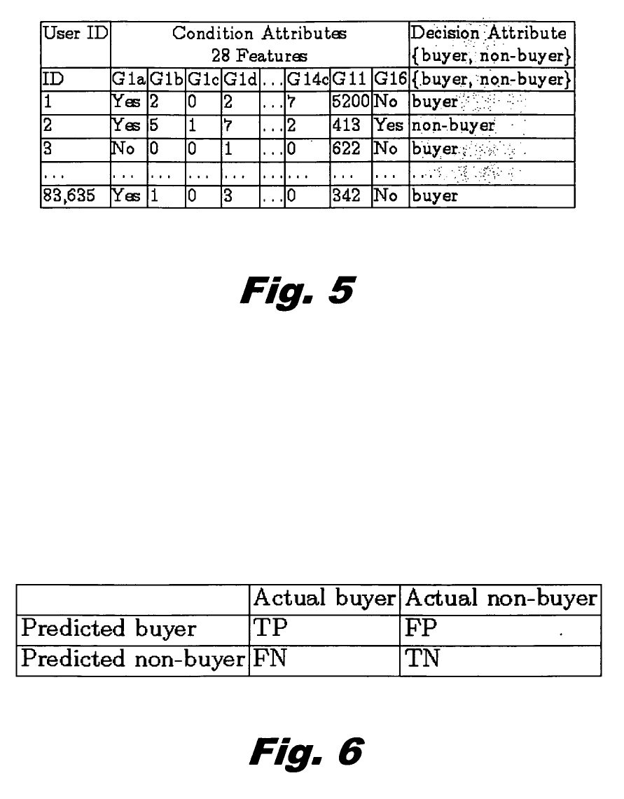

FIG. 6 is a confusion matrix illustrating the potential classifications for user, who may be a predicted buyer or a predicted non-buyer. In the matrix T stands for “True”, F stands for “False”, P stands for “Positive”, and N stands for “Negative.” For example, a predicted buyer can be an actual buyer, resulting in a classification of “TP” or “true positive.” This indicates that the model has correctly predicted that the predicted buyer does, in fact, become an actual buyer. Alternatively, the user who was a predicted buyer may actually be a non-buyer, resulting in the classification of “FP” or “false positive.” Similarly, the user may be a predicted non-buyer, but then does actually make the purchase becoming an actual buyer and resulting in a classification of “FN” or “false negative.” The predicted non-buyer could also actually be a non-buyer, resulting in a classification of “TN” or “true negative.”

For an idealized model that is completely accurate, all predicted buyers would be actual buyers and would be classified as “TP” and all predicted non-buyers would be actual non-buyers and classified as “TN.” However, the difficulty in making accurate predictions based on site-centric clickstream data results in real world models that have much lower rates of true positive and true negative.

A number of evaluation metrics can be created using the classifications shown in Table 4. Specifically, precision, recall, true positive rate, and true negative rate are listed below and used to evaluate the performance of statistical models.

$$\begin{matrix}PRECISION = \frac{TP}{TP + FP} & Eq . 3 \\ RECALL = \frac{TP}{TP + FN} & Eq . 4 \\ TRUE\_POSITIVE \_RATE = \frac{TP}{TP + FN} & Eq . 5 \\ FALSE\_POSITIVE \_RATE = \frac{FP}{FP + TN} & Eq . 6\end{matrix}$$

In a statistical classification task, the precision for a class is the number of true positives (i.e. the number of items correctly labeled as belonging to the class) divided by the total number of elements labeled as belonging to the class (i.e. the sum of true positives and false positives, which are items incorrectly labeled as belonging to the class). Recall is defined as the number of true positives divided by the total number of elements that actually belong to the class (i.e. the sum of true positives and false negatives, which are items which were not labeled as belonging to that class but should have been).

In a classification task, a precision score of 1.0 for a class C means that every item labeled as belonging to class C does indeed belong to class C (but says nothing about the number of items from class C that were not labeled correctly). A recall score of 1.0 means that every item from class C was labeled as belonging to class C (but says nothing about how many other items were incorrectly labeled as also belonging to class C).

Often, there is an inverse relationship between precision and recall, where it is possible to increase one at the cost of reducing the other. For example, an information retrieval system (such as a search engine) can often increase its recall by retrieving more documents, at the cost of increasing the number of irrelevant documents retrieved (decreasing precision). Similarly, a classification system for deciding whether or not, say, a fruit is an orange, can achieve high precision by only classifying fruits with the exact right shape and color as oranges, but at the cost of low recall due to the number of false negatives from oranges that did not quite match the specification.

### Decision Tree Classifier

Various classification experiments were performed and evaluated using the above metrics. In one experiment, a decision tree was used to represent discrete-valued functions (or features) that become classifiers for predictions. For a given decision attribute C (assuming that buyer or non-buyer are the only two classes in the system), the information gain is:

$$I ( buyer , non \text{-} buyer ) = - {\sum }_{i}^{2} {p}_{i} {log}_{2} ( {p}_{i} ) \qquad Eq . 7$$

There are different decision tree implementations available. In this illustrative embodiment, a C4.5 decision tree implementation for classification rule generation is used. The C4.5 implementation uses attributes of the data to divide the data into smaller subsets. C4.5 examines the information gain (see Eq. 7) that results from choosing an attribute for splitting the data. The attribute with the highest normalized information gain is the one used to make the decision. The algorithm is then reapplied to the smaller subsets.

An example of a decision tree implementation is given in FIG. 1 for purchase behavior within a computer product category. The overall goal of the decision tree is to categorize the users into buyers and non-buyers using various features within the clickstream data.

In the example of purchasing a computer, the C4.5 algorithm determined that the feature which produced the greatest information gain was whether the user visited a computer retailer website. Consequently, this was used as the base feature to apply to the clickstream data. The C4.5 algorithm was then applied to each of the two resulting data subsets. Among the user who did not visit a computer retailer website, it was found that the next most significant increase in information gain was achieved by dividing the user subset into those who had visited a review website and those who had not. For the subset of users who had neither visited a retailer website nor visited a review site, there were no purchasers, so further sub-categorization was not necessary. Consequently, the prediction was made that this subset of users would not purchase a computer product within a predefined time frame.

Other features were also defined to subcategorize the subset of users who did not visit a retailer website, but did visit a review website. Similarly, those who did visit a retailer website were subcategorized into additional subsets that allow the model to predict buyers and non-buyers of computer products.

For some features, the criterion used to divide the users is straight forward. For example, each of the users either visited a retailer website or they didn't. However, some features include numeric thresholds which can be adjusted to fine tune the decision tree. For example, a feature may divide the users based on: “Did the user view more than 30 pages at a retailer website?” Ideally, the “30 page” threshold represents the best criteria for dividing the users into two sub groups, such as purchasers and non-purchasers. These feature thresholds are initially calculated during feature generation and can be subsequently optimized to fine tune the decision tree classification.

The feature generation and decision tree construction process was repeated for each of the 28 purchasing categories using a training data set. The resulting decision trees were then applied to user clickstream data that was outside of the training data set. The decision trees resulted in surprisingly high quality predictions, with a precision of 29.47%, and a recall 8:37%. These results likely represent lower bounds on the accuracy of the model due to large number of customers who perform research about various products online and then make purchase at a brick-and-mortar store. The brick-and-mortar store purchaser that was correctly predicted as a purchaser will be incorrectly labeled as a false positive because data that captures their actual purchase is not included in the clickstream data.

These results indicate that a decision tree be highly successful as a classifier for online product purchasing prediction. Additionally, the decision tree model can use a variety of methods for progressive learning and iterative improvement. For example, as larger data sets are accumulated for one or more users, the decision tree model could be adjusted to more precisely generate relevant features and more accurately identify future purchasers. Further, optimum threshold values could be calculated using a number of methods, including the logistic regression classifier described below.

### Logistic Regression Classification

To create a classifier based logistic regression, a statistical regression model can be used for binary dependent variable prediction. By measuring the capabilities of each of the independent variables, the probability of buyer or non-buyer occurrence can be estimated. The coefficients are usually estimated by maximum likelihood, and the logarithm of the odds (given in Eq. 8) is modeled as a linear function of the 28 features.

$$log ( \frac{p}{1 - p} ) \qquad Eq . 8$$

Thus, the probability of the user being a buyer can be estimated by:

$$P = \frac{{ɛ}^{α + {β}_{1} {x}_{1} + {β}_{2} {x}_{2} + … + {β}_{n} {x}_{n}}}{1 + {ɛ}^{α + {β}_{1} {x}_{1} + {β}_{2} {x}_{2} + … + {β}_{n} {x}_{n}}} \qquad Eq . 9$$

The default cutoff threshold of predicting a buyer is P=0.5. The precision is 18.52% and recall is 2.23%, where the cutoff threshold is P=0.5. By varying the different cutoff threshold, the classification performance of the model can be adjusted.

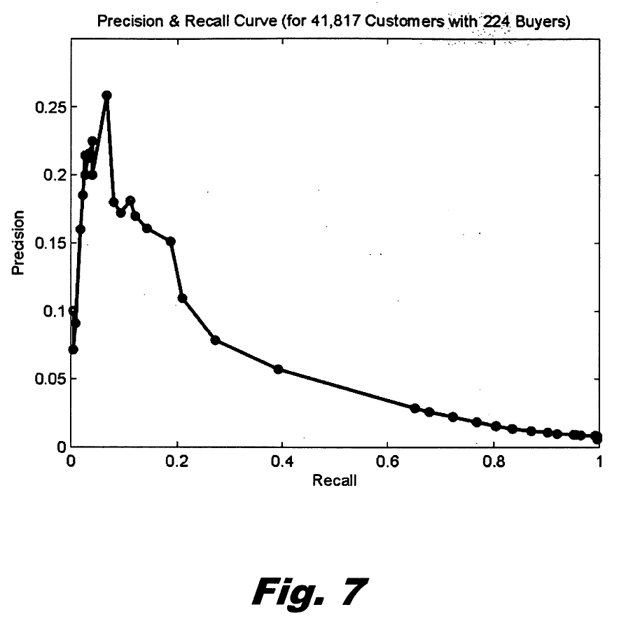

FIG. 7 is graph of a precision/recall curve generated by the logical regression classification over varying threshold values. The precision of the model is shown on the vertical axis of the graph and the recall is shown along the horizontal axis of the graph. Higher threshold values generally result in higher precision (predicted buyers are more likely to be actual buyers) but lower recall (fewer of the actual buyers are identified as predicted buyers).

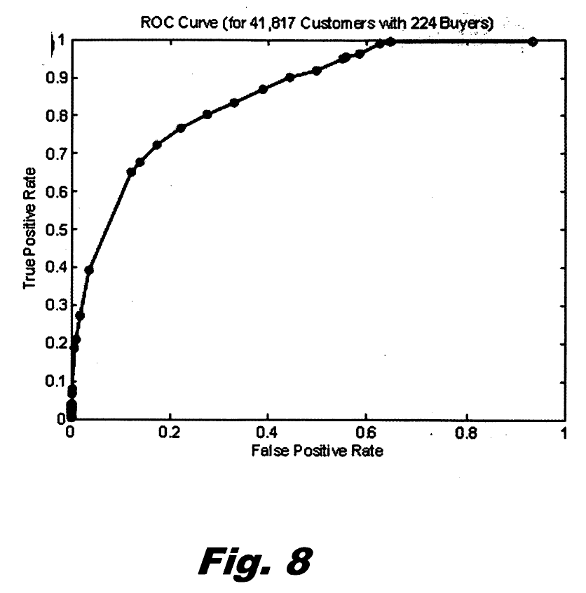

FIG. 8 is an illustrative Relative Operating Characteristic (ROC) curve for varying threshold values within the logical regression model. The true positive rate is graphed on the vertical axis and the false positive rate is graphed along the horizontal axis. For very high thresholds, the true positive rate and the false positive rate would be expected to be very low because the model only generates a few predicted buyers. Consequently, the true positive rate is low because the predicted buyers represent only a small fraction of the actual buyers. The false positive rate is very low because with very high thresholds it is unlikely that the relatively few predicted buyers are actually non-buyers. As the threshold values decrease, the true positive rate increases as more of the actual buyers are identified. The false positive rate also increases as more actual non-buyers are wrongly identified as predicted buyers.

The principles underlying the charts illustrated in FIGS. 7 and 8 can be used with a variety of models to compare various classification models and optimize cutoff thresholds to achieve the desired model performance.

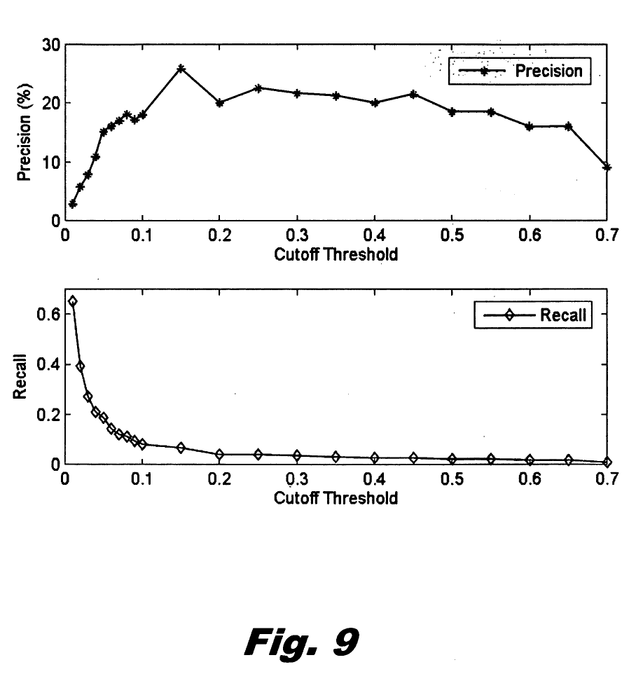

FIG. 9 shows illustrative relationships between cutoff threshold and precision/recall measures for the logistic regression model. These plots can be used for determining the suggested cutoff threshold in order to reach a satisfied precision and recall in classification applications. In both graphs, the cutoff threshold is shown along the horizontal axis. In the top graph, the precision of the model (in percent) is shown alone the vertical graph. In the bottom graph, the recall of the model is shown along the vertical axis. The maximum precision of about 27% is obtained with a threshold value of 0.15. The corresponding recall is about 0.07 for the same threshold. Thus, for a threshold value of 0.15, 27% of predicted buyers were actual buyers. The accurately predicted actual buyers represented 7% of the total population of actual buyers. It should be pointed out these values represent a significant improvement over current site-centric models. Typical site-centric models, which solve a much easier problem (“Is this user a buyer or a non-buyer on this site?”), have typical precision percentages in the single digits and recall values between about 0.01 and 0.04.

Naïve Bayes Classification

A Naïve Bayes classifier is a simple probabilistic model which assumes that the probability of various features occurring within a class are unrelated to the probability of the presence of any other feature or attribute. This strong independent assumption allows Naive Bayes classifiers to assume that the effect of an individual attribute on a given class is independent of the values of the other attributes. Despite this over-simplification, a naive Bayesian model typically has comparable classification performance with decision tree classifiers.

Given a set of condition attributes {a₁, a₂, . . . , aₙ}ε X, the Naive Bayes classifier assumes that the attribute values are conditionally independent given the class value C. Therefore:

P(C|a₁, a₂, . . . , aₙ)=arg maxₐ_{ᵢ}P(aᵢ)ΠⱼP(aⱼ|aᵢ) Eq. 10

Based on the frequencies of the variables over the training data, the estimation corresponds to the learned hypothesis, which is then used to classify a new instance as either a buyer or non-buyer of certain product categories. According to one embodiment, the Naïve Bayes implementation resulted in a precision of 23.2% and a recall of 3.52%.

### Comparison of Site-Centric Results to User-Centric Results

The user-centric classification results demonstrate effective prediction of purchase intent within various product categories. Among the “Decision Tree”, “Logistic Regression” and “Naive Bayes” algorithms, the decision tree algorithm can obtain the highest prediction precision. Logistic regression can be used as a flexible option to adjust the precision and recall for the classifiers.

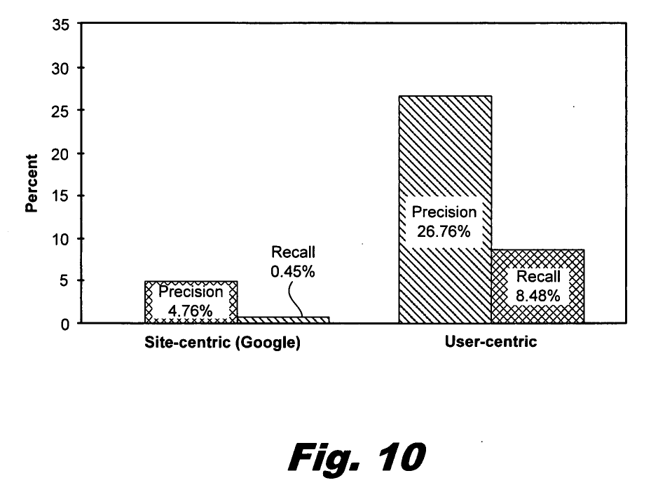

FIG. 10 is a chart showing a comparison between site-centric classifiers and user-centric classifiers. The classification performance from decision tree classifiers based on 28 user-centric features, with the best site-centric feature as single classifier from a major search engine (“people who searched laptop keywords on Google before purchasing and searched more than one session”). The precisions for the user-centric and site-centric classifiers are 26.76% vs. 4.76%, and recall are 8.48% vs. 0.45%. Using the decision tree as a classifier for user-centric purchasing prediction can increase the precision greatly, and at the same time the recall is increased as well. The result indicates user-centric classifiers provide a much higher prediction precision than site-centric classifiers on predicting user's purchasing intent.

### The Purchasing Time Window

To be valuable, the prediction of purchase likelihood must be made in advance of the actual purchase. The time between when the purchase prediction is made and the purchase actually occurs is called the “latent period.” If the latent period is too short, the value of the prediction is far lower than if the prediction is made farther in advance. For example, a prediction that a buyer will purchase a product that is made based on the buyer having already put the item in the online shopping cart and entered their credit card and shipping information will have high precision and recall, but be of little value because the buyer is only seconds away from making the actual purchase. This prediction is trivial because of the shortness of the latent period.

To determine the latent period for predictions, data from November and December 2005 was used determine how far in advance designated features could be identified in the clickstreams of actual users. One feature that was tested was: “Did the user search laptop keywords before purchasing a personal computer?” The experimental results indicate that 20.15% computer purchases can be predicted by this feature. Among these predicted transactions, only 15.59% transactions have the latent period less than one day (also termed “same-day-purchase”) and 39.25% transactions have 1-7 days of latent period (also termed “first-week-purchase”).

This experiment shows that online-shopping customers usually do not typically research and purchase higher ticket items, such as computer, in a single session. They spend some time (mostly, more than one day) doing research before their final purchase decisions, which gives time to detect purchasing interests based on behaviors, make predictions, and present the user with advertising information.

### Smart Cookies

Through experimental results described above, it has been demonstrated that the proposed model of user purchase intent prediction can be learned from user-centric clickstream data. According to one embodiment, the relatively simple classification algorithms can be deployed on the user's machine to prevent communication of private information contained in the user clickstream to outside entities. By applying the classification algorithms to the user's clickstream, predictions can be made about categories of products the user is likely to purchase and the time period in which the user will make the purchase. For example, a numeric probability could be calculated that captures “the likelihood that a user will purchase a laptop within the next month”. These model outputs can be used as intentional signals for a variety of personalization tasks such as personalizing search or serving relevant advertising.

According to one illustrative embodiment, these model outputs could be contained in a dynamic “smart cookie” that resides on the user's machine. Ordinarily browser cookies contain data generated by server and sent to the user's machine. Later, the browser cookies are retrieved by the server for authentication of the user, session tracking, and maintaining site preferences or the contents of the user's electronic shopping carts. In contrast, the “smart cookie” is generated by the user's machine and contains probability of purchase information (also called “intentional data” as the probability of purchase indicates the future intention of the user) generated by the model outputs.

The concept of a “smart cookie” protects the user's privacy by restricting access to the user's complete clickstream to the user's machine. There is no need to transmit or collect the entire clickstream across a network or to another machine. Additionally, the “smart cookie” content could be controlled such that it does not contain personally identifying information and loses its value if its association with the user or user's machine is destroyed or lost. Further, various mechanisms could be used to allow the user to control access by outside entities to the “smart cookie.”

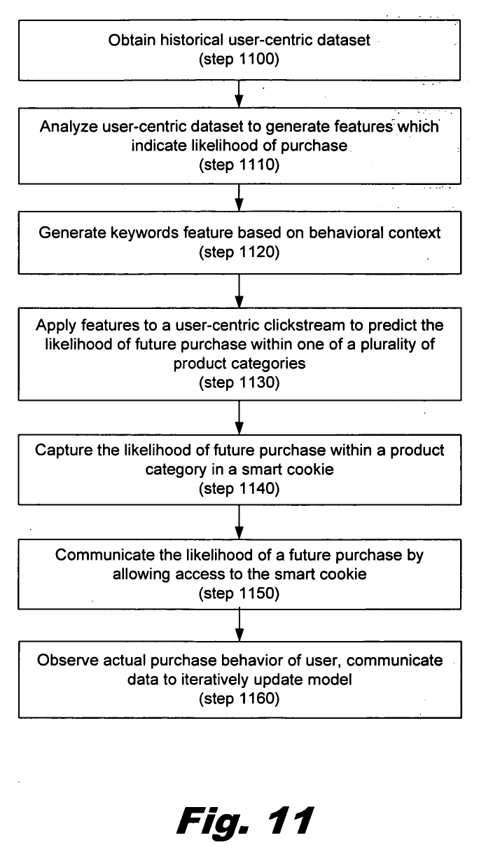

FIG. 11 is a flowchart showing an illustrative method for learning user purchase intent from user-centric data. A training data set, such as an historical user-centric data set can be obtained to initially set up the model (step 1100). The user-centric data set is used to generate features which indicate the likelihood of purchase (step 1110). Keyword features could be generated based on behavior context as described above (step 1120). According to one embodiment, client software on the user's machine would gather clickstream data, and perform the necessary processing for feature extraction or optimization on the fly. The user's machine may also possess some simple metadata to help in the feature extraction, such as a compressed lookup table representing the website classifications. The client software could also be updated with simple decision tree models and perform classifications into likelihood categories, etc., for each product category. The generated features are then applied to a user-centric clickstream in real time to predict the likelihood of purchase within one of a plurality of product categories (step 1130). These likelihoods, encoded within smart cookies (step 1140), could be communicated to search engines or to content websites upon visitation or request (step 1150). The search engines or websites would use the likelihoods to dynamically determine which ads or content to show the user. The end result would be more relevant content to users and greater revenue to content owners. Because the models would be computed from the clickstream on the client-side, privacy issues are mitigated. Additionally, the actual purchase behavior of the user could be observed and analyzed to iteratively update the model (step 1160).

### CONCLUSION

The algorithms described above demonstrate very effective product category level purchase prediction (regardless of the site of purchase) for user-centric clickstream data. Using data mining and machine learning algorithms, higher classification performance than site-centric data is obtained. Comparison experiments show that such models outperform site-centric models. The experimental results show that decision tree algorithms can generate a higher precision than some other model types; logistic regression can provide a cutoff threshold that can be used to adjust appropriate precision and recall; and behavior based search terms are significant features for predicting online product purchases. The models and system presented above are fully automatable and enable functionality for a “smart cookie” mechanism. This “smart cookie” can be deployed client-side and therefore would mitigate privacy concerns. Additionally, the model can be developed to produce richer user models, such as techniques for predicting approximate purchasing time.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of predicting user purchase intent from user-centric data comprises:
applying a classification model to a user-centric clickstream; said classification model predicting a likelihood of a future user purchase by a user within one or more product categories; and
customizing content displayed to said user based on said likelihood of future user purchase.

2. The method of claim 1, compiling said user-centric clickstream with a user's own computer.

3. The method of claim 2, further comprising recording said user-centric clickstream in a smart cookie on said user's own computer, wherein said customizing content is performed using said data from said smart cookie.

4. The method of claim 1, further comprising generating said classification model, said classification model comprising a number of features that distinguish between buyers and non-buyers within a product category.

5. The method of claim 4, wherein generating said classification model comprises analyzing a training data set of user-centric data to generate said features.

6. The method of claim 5, further comprising analyzing said training data set to extract distinguishing search terms used by actual buyers which differentiate said actual buyers within a product category from non-buyers.

7. The method of claim 1, further comprising loading said classification model on a user's own computer, said model obtaining said user's clickstream data and analyzing said user's clickstream data in real time on said user's own machine.

8. The method of claim 1, further comprising observing actual purchase behavior of said user and updating said model based on said actual purchase behavior.

9. A system of predicting user purchase intent from user-centric data comprises:
a computer programmed to record a user's clickstream data as a user accesses a plurality of different websites; and
said computer loaded with a classification model configured to predict a likelihood of a future user purchase by said user within one or more product categories based on said clickstream data.

10. The system of claim 9, further comprising an external server in communication with said computer and configured to customize content displayed to said user based on said likelihood of future user purchase.

11. The system of claim 9, wherein said computer records said user-centric clickstream data and likelihood of future user purchase in a smart cookie on said computer.

12. The system of claim 9, wherein said classification model comprising a number of features that distinguish between buyers and non-buyers within a product category.

13. A method of predicting user purchase intent from user-centric data comprises:
with a user's own computer, recording user-centric clickstream data based on visits to a plurality of different websites; and
storing a smart cooked based on said clickstream data on said user's own computer.

14. The method of claim 13, further comprising:
applying a classification model to said user-centric clickstream data; said classification model predicting a likelihood of a future user purchase by a user within one or more product categories; and
recording said likelihood of future user purchase in said smart cookie.

15. The method of claim 13, further comprising selectively transmitting data from said smart cookie to websites accessed by said user's computer, wherein said websites customize content served to said user based on said data from said smart cookie.
